(19) United States
(12) Patent Application Publication
(10) Pub. No.: US 2026/0369686 A1
(43) Pub. Date: Nov. 19, 2026

(54) Solid-State Lithium-Based Batteries With Solid Polymer Electrolyte And Methods Of Making And Using The Same

(71) Applicant: Ensurge Micropower ASA, Oslo (NO)

(72) Inventor: Zhongchun WANG, Sunnyvale, CA (US)

(21) Appl. No.: 19/656,156

(22) Filed: Apr. 23, 2026

Related U.S. Application Data
(60) Provisional application No. 63/795,384, filed on Apr. 26, 2025.

(51) Int. Cl. H01M 10/0585; H01M 4/02; H01M 4/04; H01M 10/0565; H01M 50/414; H01M 50/491

(52) U.S. Cl. CPC H01M 10/0585; H01M 4/0404; H01M 4/0411; H01M 4/0421; H01M 4/0471; H01M 10/0565; H01M 50/414; H01M 50/491; H01M 2004/028; H01M 2300/0028

(57) ABSTRACT

A solid-state lithium battery cell includes a substrate, a cathode on the substrate, an electrolyte interface layer on the cathode, a solid polymer electrolyte layer on the electrolyte interface layer, an anode-current-collector interface layer on the solid polymer electrolyte layer, and an anode current collector on the anode-current-collector interface layer. The solid polymer electrolyte layer includes a porous polymeric separator and a polymeric electrolyte at least partially extending into pores of the porous polymeric separator, the polymeric electrolyte including a polar polymer or co-polymer and a lithium salt. Methods of making the cell include depositing the cathode and interface layers, placing the porous polymeric separator, introducing a solution of the polymeric electrolyte into the porous polymeric separator, and forming the cell with the anode current collector. The disclosed structures and methods can reduce reliance on vacuum-deposited inorganic electrolytes alone while improving manufacturability, interfacial conformity, durability, and cycling performance.

### CROSS-REFERENCE TO RELATED APPLICATIONS

This application claims the benefit under 35 U.S.C. § 119(e) of US Provisional Patent Application 63/795,384, filed 2025-04-26, which is incorporated herein by reference in its entirety for all purposes.

### TECHNICAL FIELD

The present disclosure generally relates to the field of solid-state and/or thin film batteries. More specifically, examples of the present disclosure pertain to solid-state lithium batteries and microbatteries having a polyolefin-separator-supported solid polymer electrolyte, and methods of making and using the same.

### SUMMARY

Compared to the inorganic electrolyte lithium phosphorous oxynitride (LiPON) alone, which is prepared by vacuum-based physical vapor deposition (PVD), a solid polymer electrolyte can be prepared by wet processing (e.g., solution casting), which shows significant advantages in terms of cost reduction, cell and process flexibility, cell durability, and longer cell cycling lifetime.

The present solid-state battery cell comprises a substrate, a cathode, a porous polymeric separator, a solid polymer electrolyte (SPE) in the porous polymeric separator, and an anode current collector (ACC). The polymeric separator is generally chemically inert to the other components of the battery cell. The SPE includes a relatively polar (e.g., ionically conductive) polymer and an electrolyte salt. The substrate may be conductive, in which case it can function as a cathode current collector or a cathode terminal (e.g., in a packaged battery, such as a coin-type battery). The present solid-state battery cell may be anodeless or may further include an anode. The present solid-state battery cell may also include a cathode interface layer and/or an anode or ACC interface layer. Such interface layers may comprise, for example, a solid-state electrolyte material (e.g., a lithium-transition metal oxide, oxynitride, and/or phosphate, or a lithium-transition metal-lanthanide oxide, in which the transition metal may be partially substituted with one or more other metals).

A solid-state battery may include the present solid-state battery cell in a package that includes the cathode terminal and an anode terminal. The present disclosure also concerns methods of making the solid-state cell and battery.

The solid polymer electrolyte has the advantage of being sticky and conformal to the surfaces of both the cathode and the anode or ACC, which enables the use of low-cost and versatile lamination techniques for the fabrication of solid-state battery cells. Other capabilities and advantages of the present disclosure will become readily apparent from the detailed description of various examples below.

Clause 1. A method of making a solid-state lithium battery cell, the method comprising: depositing a cathode on a substrate; forming an electrolyte interface layer on the cathode; forming a solid polymer electrolyte layer over the electrolyte interface layer, wherein: forming the solid polymer electrolyte layer comprises (a) placing a porous polymeric separator on the electrolyte interface layer and (b) depositing a solution of a polymeric electrolyte onto the porous polymeric separator, the solution of the polymeric electrolyte comprises a polar polymer or co-polymer, a lithium salt, and a solvent, the solution of the polymeric electrolyte at least partially penetrates into pores of the porous polymeric separator and forms the polymeric electrolyte, in a solid form, in the pores of the porous polymeric separator; an positioning an anode current collector or an anode-current-collector interface layer and an anode current collector on the solid polymer electrolyte, thereby forming the solid-state lithium battery cell.

Clause 2. The method of clause 1, wherein depositing the cathode comprises one of sol-gel coating, screen printing, inkjet printing, spray coating, extrusion coating, pulsed laser deposition, sputtering, chemical vapor deposition, or atomic layer deposition.

Clause 3. The method of clause 1, further comprising annealing the cathode to a temperature of 500-800 °C

Clause 4. The method of clause 1, wherein forming the electrolyte interface layer comprises depositing lithium phosphorus oxynitride (LiPON), a tungsten oxide of formula WO 3+x where 0≤x≤1, or a lithium lanthanum zirconium oxide (LLZO).

Clause 5. The method of clause 1, wherein forming the electrolyte interface layer comprises RF sputtering or atomic layer deposition of LiPON.

Clause 6. The method of clause 1, wherein the electrolyte interface layer comprises carbon-doped LiPON.

Clause 7. The method of clause 1, wherein: the electrolyte interface layer comprises a tungsten oxide of formula WO 3+x where 0≤x≤1, and forming the electrolyte interface layer further comprises lithiating and annealing the tungsten oxide to convert at least a portion of the tungsten oxide to Li2WO4.

Clause 8. The method of clause 7, wherein lithiating comprises one of (a) wet lithiation by immersing the tungsten oxide in a solution containing a lithium electrolyte and applying an electric field or (b) dry lithiation by sputtering or thermally evaporating lithium onto the tungsten oxide.

Clause 9. The method of clause 1, wherein the electrolyte interface layer comprises LLZO formed from an LLZO sol-gel.

Clause 10. The method of clause 9, wherein forming the LLZO comprises spin-coating, extrusion coating, dip-coating, or drip-casting the LLZO sol-gel on the cathode.

Clause 11. The method of clause 9, further comprising annealing the LLZO at 500-800 °C for 1-60 minutes in an oxygen-containing gas.

Clause 12. The method of clause 1, wherein: the porous polymeric separator comprises polyethylene, polypropylene, or polyimide, the porous polymeric separator has a thickness of 1-20 micrometers, and the pores of the porous polymeric separator have an average pore size of 20-500 nm.

Clause 13. The method of clause 1, wherein the polar polymer or co-polymer comprises one of poly(ethylene oxide) having a molecular weight of 2,000-1,000,000 g/mol, ethylene oxide, vinyl alcohol, an acrylic acid ester, a methacrylic acid ester, 4-hydroxybutanoic acid lactone, or 5-hydroxypentanoic acid lactone.

Clause 14. The method of clause 1, wherein the lithium salt comprises lithium chloride, lithium iodide, lithium bis(trifluoromethanesulfonyl)imide, lithium trifluoromethanesulfonate, lithium methylsulfonate, lithium trifluoroacetate, lithium tetrafluoroborate, or lithium hexafluorophosphate.

Clause 15. The method of clause 1, wherein the solvent comprises acetonitrile, tetrahydrofuran, dioxane, dimethoxyethane, bis(2-methoxyethyl) ether, methyl acetate, ethyl acetate, or dimethylformamide.

Clause 16. The method of clause 1, wherein the polar polymer or co-polymer is present in the solution at a concentration of 1-300 g/L.

Clause 17. The method of clause 1, wherein the lithium salt is present in the solution at a concentration of 5-500 mmol/L.

Clause 18. The method of clause 1, wherein a molar ratio of lithium-binding groups in the polar polymer or co-polymer to lithium ions in the lithium salt is from 1:1 to 100:1.

Clause 19. The method of clause 1, wherein forming the solid polymer electrolyte layer further comprises depositing the solution of the polymeric electrolyte onto the electrolyte interface layer before placing the porous polymeric separator on the electrolyte interface layer.

Clause 20. The method of clause 1, wherein depositing the solution of the polymeric electrolyte comprises depositing an additional amount of the solution onto the porous polymeric separator after placing the porous polymeric separator on the electrolyte interface layer.

Clause 21. The method of clause 1, wherein the anode-current-collector interface layer is positioned between the solid polymer electrolyte and the anode current collector.

Clause 22. The method of clause 21, wherein the anode-current-collector interface layer comprises LiPON, Li2WO4, or LLZO.

Clause 23. The method of clause 1, wherein positioning the anode current collector or the anode-current-collector interface layer and the anode current collector comprises laminating a sheet or roll containing the anode current collector or the anode-current-collector interface layer and the anode current collector onto the solid polymer electrolyte layer.

Clause 24. The method of clause 1, wherein the substrate, the cathode, the electrolyte interface layer, the solid polymer electrolyte layer, and the anode current collector or the anode-current-collector interface layer and the anode current collector are provided in a multi-cell sheet or roll form and laminated together to form a plurality of solid-state lithium battery cells.

Clause 25. The method of clause 1, wherein positioning the anode current collector or the anode-current-collector interface layer and the anode current collector comprises positioning a lithium metal anode on the solid polymer electrolyte and positioning the anode current collector on the lithium metal anode.

Clause 26. The method of clause 25, wherein the lithium metal anode comprises a lithium foil laminated onto the solid polymer electrolyte.

Clause 27. The method of clause 25, wherein the anode current collector is deposited on the lithium metal anode by evaporation, sputtering, chemical vapor deposition, or atomic layer deposition.

Clause 28. The method of clause 1, wherein positioning the anode current collector or the anode-current-collector interface layer and the anode current collector comprises positioning the anode-current-collector interface layer on the solid polymer electrolyte and positioning the anode current collector on the anode-current-collector interface layer to form an anodeless solid-state lithium battery cell.

Clause 29. The method of clause 1, wherein the anode current collector comprises copper, nickel, zinc, tungsten, vanadium, or an alloy thereof.

Clause 30. The method of clause 1, wherein the solid-state lithium battery cell is a coin cell, and the method further comprises placing the cathode in a cathode portion of a coin-cell package, forming the solid polymer electrolyte layer thereon, placing a lithium foil anode or an anode-current-collector-interface-layer-coated anode current collector thereon, and crimping an anode portion of the coin-cell package to the cathode portion.

Clause 31. A solid-state lithium battery cell comprising: a substrate; a cathode on the substrate; an electrolyte interface layer on the cathode; a solid polymer electrolyte layer on the electrolyte interface layer, wherein: the solid polymer electrolyte layer comprises a porous polymeric separator and a polymeric electrolyte, at least partially extending into pores of the porous polymeric separator, and the polymeric electrolyte comprises a polar polymer or co-polymer and a lithium salt; an anode-current-collector interface layer on the solid polymer electrolyte layer; and an anode current collector on the anode-current-collector interface layer.

Clause 32. The solid-state lithium battery cell of clause 31, wherein: the substrate is formed as a metal foil, a metal plate, or a metal coating on a mechanical substrate, and the substrate comprises stainless steel, aluminum, copper, nickel, inconel, brass, molybdenum, titanium, or an alloy thereof.

Clause 33. The solid-state lithium battery cell of clause 31, wherein: the substrate further comprises a barrier configured to inhibit migration of atoms or ions from the substrate into the cathode, and the barrier comprises an electrically conductive refractory metal nitride, a glass, a ceramic, or a combination thereof.

Clause 34. The solid-state lithium battery cell of clause 33, wherein the barrier comprises a first metal nitride layer, a glass or ceramic layer on the first metal nitride layer, and a second metal nitride layer on the glass or ceramic layer.

Clause 35. The solid-state lithium battery cell of clause 33, wherein the barrier comprises aluminum nitride, titanium nitride, titanium aluminum nitride, tungsten nitride, titanium tungsten nitride, tantalum nitride, silicon dioxide, aluminum oxide, silicon nitride, a silicon oxynitride, an aluminum oxynitride, or a combination thereof.

Clause 36. The solid-state lithium battery cell of clause 33, wherein the barrier comprises alternating layers of a metal nitride and a glass or ceramic.

Clause 37. The solid-state lithium battery cell of clause 33, wherein the barrier has a total thickness of 0.5-3 micrometers.

Clause 38. The solid-state lithium battery cell of clause 31, wherein the cathode comprises one of lithium cobalt oxide, lithium manganese oxide, lithium iron phosphate, or a nickel-manganese-cobalt oxide.

Clause 39. The solid-state lithium battery cell of clause 31, wherein the electrolyte interface layer comprises one or more materials selected from the group consisting of lithium phosphorus oxynitride, carbon-doped lithium phosphorus oxynitride, Li2WO4, lithium lanthanum zirconium oxide, and lithium lanthanum zirconium oxide in which zirconium is partially substituted with niobium, tantalum, aluminum, gallium, indium, vanadium, antimony, and hafnium.

Clause 40. The solid-state lithium battery cell of clause 39, wherein the electrolyte interface layer comprises lithium phosphorus oxynitride.

Clause 41. The solid-state lithium battery cell of clause 39, wherein the electrolyte interface layer comprises carbon-doped lithium phosphorus oxynitride.

Clause 42. The solid-state lithium battery cell of clause 31, wherein the electrolyte interface layer has a thickness of 20-500 nanometers.

Clause 43. The solid-state lithium battery cell of clause 31, wherein: the porous polymeric separator comprises polyethylene, polypropylene, a polyimide, or a combination thereof, the porous polymeric separator has an average pore size of 20-500 nanometers, and the porous polymeric separator has a thickness of 1-20 micrometers.

Clause 44. The solid-state lithium battery cell of clause 31, wherein the polar polymer or co-polymer comprises a polymer or co-polymer of ethylene oxide, vinyl alcohol, an acrylic acid ester, a methacrylic acid ester, 4-hydroxybutanoic acid lactone, or 5-hydroxypentanoic acid lactone.

Clause 45. The solid-state lithium battery cell of clause 31, wherein the polar polymer or co-polymer comprises poly(ethylene oxide) having a weight-average or number-average molecular weight of 5,000-500,000 g/mol.

Clause 46. The solid-state lithium battery cell of clause 31, wherein the lithium salt comprises lithium chloride, lithium iodide, lithium bis(trifluoromethanesulfonyl)imide, lithium trifluoromethanesulfonate, lithium methylsulfonate, lithium trifluoroacetate, lithium tetrafluoroborate, lithium hexafluorophosphate, or a lithium salt of another non-coordinating chemically stable anion.

Clause 47. The solid-state lithium battery cell of clause 46, wherein the lithium salt comprises lithium bis(trifluoromethanesulfonyl)imide.

Clause 48. The solid-state lithium battery cell of clause 31, wherein the polymeric electrolyte has an ionic conductivity greater than 10\hat{ }-5 S cm\hat{ }-1.

Clause 49. The solid-state lithium battery cell of clause 31, wherein the polymeric electrolyte is conformal to a surface of the electrolyte interface layer and a surface of the anode-current-collector interface layer.

Clause 50. The solid-state lithium battery cell of clause 31, wherein the anode-current-collector interface layer comprises lithium phosphorus oxynitride, Li2WO4, or lithium lanthanum zirconium oxide.

Clause 51. The solid-state lithium battery cell of clause 50, wherein the anode-current-collector interface layer comprises lithium phosphorus oxynitride.

Clause 52. The solid-state lithium battery cell of clause 31, wherein the anode-current-collector interface layer has a thickness of 20-500 nm.

Clause 53. The solid-state lithium battery cell of clause 31, wherein the anode current collector comprises nickel, zinc, copper, tungsten, vanadium, an alloy thereof, or graphite.

Clause 54. The solid-state lithium battery cell of clause 31, wherein the cell is an anodeless solid-state lithium battery cell.

Clause 55. The solid-state lithium battery cell of clause 31, further comprising an anode, as a lithium metal layer, between the anode-current-collector interface layer and the solid polymer electrolyte layer.

### BRIEF DESCRIPTION OF THE DRAWINGS

FIG. 1A shows a block diagram of a solid-state lithium battery (SSLB) cell, in accordance with some examples.

FIG. 1B is a process flowchart of a method for fabricating a solid-state lithium battery (SSLB) cell, in accordance with some examples.

FIGS. 2-5 are images of devices in a method of making a half-cell for a coin battery in accordance with the example below.

FIG. 6 is a graph showing the charge capacity and discharge capacity for each of a plurality of cycles of an all-solid-state coin battery, including the half-cell made in accordance with the example below.

FIG. 7 is a graph showing the capacity of the solid-state coin battery in accordance with the example below.

FIG. 8 is a graph showing the coulombic efficiency (CE) of the solid-state coin battery in accordance with the example below.

### DETAILED DESCRIPTION

Reference will now be made in detail to one or more examples of the disclosure, examples of which are illustrated in the accompanying drawings. While the disclosure will be described in conjunction with the following examples, it will be understood that the descriptions are not intended to limit the disclosure to these examples. On the contrary, the disclosure is intended to cover alternatives, modifications, and equivalents that may be included within the spirit and scope of the disclosure. Furthermore, in the following detailed description, numerous specific details are set forth in order to provide a thorough understanding of the present disclosure. However, it will be readily apparent to one skilled in the art that the present disclosure may be practiced without these specific details. In other instances, well-known methods, procedures, and components have not been described in detail so as not to unnecessarily obscure aspects of the present disclosure. Furthermore, it should be understood that the possible permutations and combinations described herein are not meant to limit the disclosure. Specifically, variations that are not inconsistent may be mixed and matched as desired.

The technical proposal(s) of examples of the present disclosure will be fully and clearly described in conjunction with the drawings in the following examples. It will be understood that the descriptions are not intended to limit the disclosure to these examples. Based on the described examples of the present disclosure, other examples can be obtained by one skilled in the art without creative contribution and are within the scope of legal protection given to the present disclosure.

Furthermore, all characteristics, measures, or processes disclosed in this document, except characteristics and/or processes that are mutually exclusive, can be combined in any manner and in any combination possible. Any characteristic disclosed in the present specification, claims, Abstract, and Figures can be replaced by other equivalent characteristics or characteristics with similar objectives, purposes, and/or functions, unless specified otherwise.

For the sake of convenience and simplicity, “part,” “portion,” and “region” may be used interchangeably herein, but are generally given their art-recognized meanings. Wherever one such term is used, it also encompasses the other terms. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The term “length” generally refers to the largest dimension of a given 3-dimensional structure or feature. The term “width” generally refers to the second largest dimension of a given 3-dimensional structure or feature. The term “thickness” generally refers to the smallest dimension of a given 3-dimensional structure or feature. The length and the width, or the width and the thickness, may be the same in some cases. A “major surface” refers to a surface defined by the two largest dimensions of a given structure or feature, which, in the case of a structure or feature having a circular surface, may be defined by the radius of the circle.

The terms “lower” and “upper” are used herein as convenient labels for the same or similar structures having a relative position to the other(s) as shown in the drawings, but which can change their relative position(s) depending on the orientation of the apparatus or other structure in the drawing(s). Similarly, the terms “downstream” and “upstream” are convenient labels for relative positions of two or more components of an apparatus or system with respect to the flow of one or more gases or fluids within the apparatus or system. Also, for convenience and simplicity, the terms “connected to,” “coupled with,” “coupled to,” “joined to,” “attached to,” “fixed to,” “affixed to,” “in communication with,” and grammatical variations thereof may be used interchangeably, and refer to both direct and indirect connections, couplings, joints, attachments and communications (unless the context of its use unambiguously indicates otherwise), but these terms are also generally given their art-recognized meanings.

For convenience, the terms “solid polymer electrolyte” and “SPE” may refer to a combination of the porous polymeric separator, the relatively polar polymer, and the electrolyte salt, or just the relatively polar (e.g., ionically conductive) polymer and the electrolyte salt.

### Examples of Solid-state Battery Cells With a Solid Polymer Electrolyte

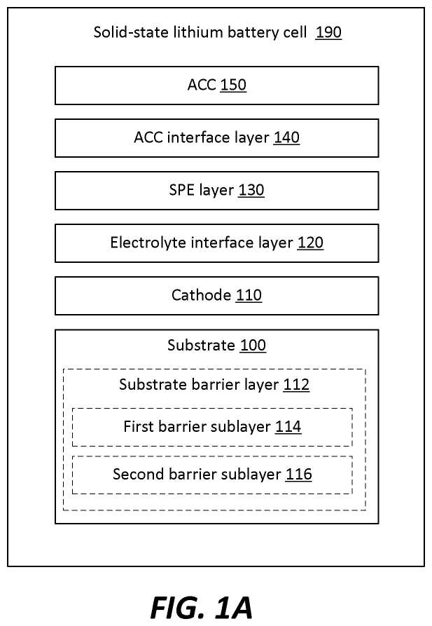

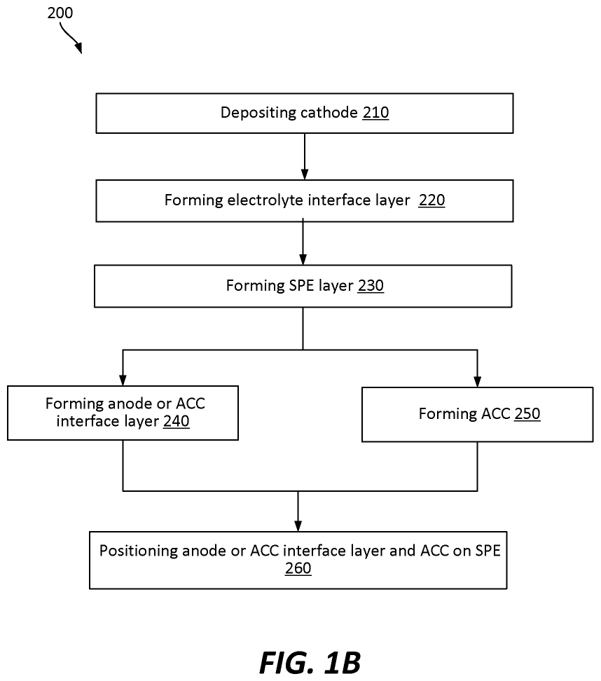

FIG. 1A shows a block diagram of a solid-state lithium battery cell 190, in accordance with some examples. The solid-state lithium battery cell 190 may comprise a substrate 100, a cathode 110, an electrolyte interface layer 120, a solid polymer electrolyte (SPE) layer (i.e., an SPE layer 130), an anode or anode current collector (ACC) interface layer (i.e., an ACC interface layer 140), and an anode current collector (ACC) 150. As will be described in greater detail below, one or more SSLB cells 190 can be assembled into solid-state lithium batteries and microbatteries having various forms (e.g., coin, square, rectangle, cylinder, irregular, etc.).

The substrate 100 can be a base or cup for a coin battery, or a metal sheet or foil. In some examples, the substrate 100 comprises a metal foil, which may comprise or consist essentially of stainless steel, aluminum, copper, nickel, inconel, brass, molybdenum, or titanium. In further examples, the elemental metals of the above-referenced elements may be alloyed with up to 10% of one or more other elements to improve one or more physical and/or chemical properties thereof (e.g., oxygen and/or water permeability, flexibility, resistance to corrosion or chemical attack during subsequent processing, etc.). However, the substrate 100 can also be a metal plate, and the metal foil may be in the form of a sheet or roll. For example, the metal foil may be 5-250 micrometers thick, 10-100 micrometers thick, or even 20-80 micrometers thick, whereas a metal plate may have a thickness of >100 micrometers, up to about 1-2 mm, although the disclosure is not so limited. Alternatively, the substrate 100 may include a metal coating having a thickness of 1-100 micrometers or 2-20 micrometers on a mechanical substrate, such as aluminum, copper, nickel, titanium, etc., on an inert ceramic or polymer sheet or a ceramic plate. When the substrate 100 includes a metal foil, plate, or coating, the substrate 100 may also function as the cathode current collector (CCC) for the battery cell.

In some examples, the substrate 100 may further include a substrate barrier layer 112 that comprises one or more barrier sublayers (e.g., a first barrier sublayer 114 and a second barrier sublayer 116) of one or more materials in a thickness effective to prevent migration of atoms or ions from the metal foil, plate, or coating into overlying layers. The barrier material(s) may comprise an electrically conductive material, such as a (refractory) metal nitride (e.g., aluminum nitride, titanium nitride, titanium aluminum nitride, tungsten nitride, titanium tungsten nitride, TiW alloy, tantalum nitride, etc.), or a glass or ceramic, such as silicon dioxide, aluminum oxide, silicon nitride, silicon and/or aluminum oxynitride, etc. Some examples (e.g., first barrier sublayer 114 and second barrier sublayer 116) include alternating glass/ceramic and metal nitride layers (e.g., a first metal nitride layer, a first glass/ceramic layer, and a second metal nitride layer, which may further comprise a second glass/ceramic layer, a third metal nitride layer, etc.). The substrate barrier layer 112 may have a total thickness of 0.5-3 μm, but the barrier is not limited to this range. The substrate barrier layer 112 may be blanket-deposited onto the substrate 100 by chemical or physical vapor deposition (e.g., sputtering, thermal evaporation, atomic layer deposition [ALD], etc.), solution-phase coating with a precursor material followed by annealing to form the glass/ceramic or metal nitride (which may result in the substrate barrier layer 112 effectively coating all surfaces of the substrate), etc.

The cathode 110 may comprise a lithium metal oxide, such as a lithium-transition metal oxide (e.g., LiMO₂, M=Co, Ni or Mn, such as lithium cobalt oxide [LiCoO₂; LCO]) and lithium manganese oxide [LiMn₂O₄; LMO]), a layered lithium-transition metal oxide (e.g., Li_{4/3-x}Ni²⁺ₓMn⁴⁺_{2/3-x}Co³⁺ₓO₂, sometimes termed “Li-rich NMC”), or a fully-oxidized lithium-transition metal compound for cathodes, such as lithium iron phosphate (LiFePO₄; LFP) or a nickel-manganese-cobalt oxide (NMC, which may include Li-rich NMCs and others). Alternatively, the cathode 110 may be replaced with an anode or ACC interface layer (e.g., Li₄Ti₅O₁₂).

The electrolyte interface layer 120 is operable as a buffer between the cathode 110 and the overlying SPE layer 130. In some examples (e.g., when the SPE material is electrochemically unstable at high voltages), the SPE layer 130 may undergo partial decomposition when placed in direct contact with the cathode 110. Thus, the electrolyte interface layer 120 prevents the direct contact of the SPE layer 130 with the cathode 110 and so prevents cycling degradation of the solid-state battery cells.

In some examples, the electrolyte interface layer 120 may comprise an inorganic solid-state electrolyte material, such as lithium phosphorus oxynitride (LiPON, which may optionally be carbon-doped), Li₂WO₄, or one or more layers of a lithium lanthanum zirconium oxide (LLZO; e.g., Li₇La₃Zr₂O₁₂, in which some of the Zr may be substituted with one or more of niobium, tantalum, aluminum, gallium, indium, vanadium, antimony or hafnium). In the case of doped and undoped LLZO, it can be formed by a sol-gel process, optionally with micropores, which may facilitate Li ion transport.

In general, the electrolyte interface layer 120 is relatively thin. For example, the electrolyte interface layer 120 may have a thickness in the range of 10-1,000 nanometers, 20-500 nanometers, or even 50 -250 nanometers, but the disclosure is not limited to these ranges.

The solid polymer electrolyte (SPE) layer 130 generally comprises a polymer separator 132 (e.g., support or spacer) and a polymeric electrolyte 134. The polymer separator 132 is generally porous (e.g., the polymer separator 132 contains micropores having an average pore size/diameter of 10-1000 nanometers, 20-500 nanometers, or 50 -250 nanometers and provides mechanical stability for the polymeric electrolyte 134. As a result, the thickness of the polymer separator 132 generally determines the thickness of the SPE layer 130. However, the SPE layer 130 may be thicker than the polymer separator 132 (e.g., by up to 50-100% or more), due to swelling as a result of the polymeric electrolyte 134 filling or infusing into the pores of the polymer separator.

The polymer separator 132 may comprise polyethylene, polypropylene, a polyimide, or a similar polymer having some degree of porosity, chemical inertness towards the other components of the cell, and an ability to form thin films or sheets. The polymer separator 132 may have a thickness of 0.5-50 micrometers, 1-20 micrometers, or 3-15 nanometers, but a thickness at the smaller end of the range may be used to maximize the energy density of the cell and battery.

The polymeric electrolyte 134 generally comprises a polymer or co-polymer of a relatively polar monomer (e.g., ethylene oxide, vinyl alcohol, an acrylic or methacrylic acid ester of a C₁-C₄ alcohol, 4-hydroxybutanoic acid lactone, 5-hydroxypentanoic acid lactone, etc.) and a lithium halide or pseudohalide salt. In some examples, the polymer for the polymeric electrolyte 134 is poly(ethylene oxide), which may have a weight-average or number-average molecular weight in the range of 5000-500,000 g/mol, or any value or range of values therein. The lithium halide or pseudohalide salt may comprise lithium chloride, lithium iodide, lithium bis(trifluoromethane-sulfonyl)imide (LiTFSI), lithium trifluoromethylsulfonate, lithium methylsulfonate, lithium trifluoroacetate, lithium tetrafluoroborate, lithium hexafluorophosphate, and lithium salts of other relatively non-coordinating, chemically stable anions. The lithium halide or pseudohalide salt may be present in the relatively polar polymer in a concentration sufficient to provide a desired ion mobility or conductivity (e.g., ≥10⁻⁵ S cm⁻¹, 3×10⁻⁴ S cm⁻¹, 10⁻⁴ S cm⁻¹, or any other ion mobility or ionic conductivity >10⁻⁵ S cm⁻¹, although the disclosure is not limited to such values).

A solid-state lithium battery cell 190 may include either an anode (e.g., lithium metal) or an ACC interface layer 140, depending on whether the cell is anode-less at the time of its preparation. In anode-less examples, the cells contain an ACC interface layer 140, which may comprise an inorganic solid-state electrolyte material, similar or identical to the materials recited above for the electrolyte interface layer 120. The ACC interface layer 140 may also have a thickness in the range of 20-500 nm, or any thickness or range of thicknesses therein (e.g., 50-200 nm), but the disclosure is not limited to this particular range. When the cell contains an anode, the anode comprises a thin film or sheet of lithium metal.

The anode current collector (ACC) 150 generally comprises a conductive metal, such as nickel, zinc, copper, tungsten, vanadium, alloys thereof (e.g., NiTi, NiV), etc., or another conductor, such as graphite. In some examples, the conductive metal for the ACC 150 is incapable of forming an alloy with lithium (e.g., a non-Li alloying metal or alloy). The ACC 150 may have a thickness of 0.1-5 μm, or any thickness or range of thicknesses therein (e.g., 0.2-2 μm), although it is not limited to this range.

### Examples of Methods of Making a Solid-state Battery Cell

FIG. 1B is a process flowchart corresponding to a method 200 of fabricating a solid-state lithium battery cell 190 (e.g., shown in FIG. 1A), in accordance with some examples. Method 200 may involve (block 210) depositing cathode 110 onto the substrate 100 by coating (e.g., using a sol-gel). Alternatively, the cathode 110 may be deposited (selectively in some cases) by screen printing, inkjet printing, spray coating, or extrusion coating using an ink comprising one or more precursors of the materials described herein and one or more solvents, the ink having a viscosity appropriate for the printing or coating technique. In yet further alternatives, the cathode 110 may be blanket deposited by laser deposition (e.g., pulsed laser deposition or PLD), sputtering, chemical vapor deposition (CVD), atomic layer deposition (ALD), etc. After deposition, the cathode 110 may be annealed (e.g., at a temperature of 500-800 °C, or any temperature or range of temperatures therein) for a length of time sufficient to achieve a predetermined or desired crystalline or other morphological structure.

Method 200 may involve (block 220) forming the electrolyte interface layer 120 by depositing a LiPON layer or a tungsten oxide layer of the formula WO₃₊ₓ (0≤x≤1) by sputtering, optionally using pulsed DC power. When the electrolyte interface layer 120 comprises LiPON, it may be deposited by RF sputtering or ALD. The sputtering target may comprise a Li₃PO₄ or mixed graphite-Li₃PO₄ target, the latter of which may contain 1-15 wt % of graphite, when the electrolyte interface layer 120 comprises LiPON or carbon-doped LiPON, and a metallic/elemental tungsten target when the electrolyte layer 140 comprises a tungsten oxide. In the latter case, sputtering is performed in an oxygen or oxygen-containing atmosphere. The process of forming the electrolyte interface layer 120 may further comprise lithiating and thermally annealing the WO₃₊ₓ, which can transform it into Li₂WO₄. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 100). Thermal annealing may comprise heating at a temperature of 150-500 °C for a length of time of 5-240 minutes, or any temperature or length of time therein (e.g., 250-450 °C for 10-120 minutes), in a convection oven, a vacuum oven, or a furnace. To ensure substantially complete diffusion of lithium into and/or throughout the WO₃₊ₓ, the WO₃₊ₓ should be annealed (e.g., in air) at a temperature of at least 100 °C for at least 10 minutes.

An LLZO electrolyte interface layer 120 may be formed by depositing an LLZO sol-gel (e.g., by spic-coating, extrusion coating, dip-coating, drip-casting, etc.) on the cathode 110 (e.g., in the form of a sheet or roll), then annealing at a temperature in the range of 500-800 °C, or any value or range of values therein, for 1-60 minutes in an oxygen-containing gas such as clean dry air (CDA). The sol-gel method of forming the electrolyte interface layer 120 has the advantages of forming a solid-state electrolyte interface layer 120 with a planar or substantially planar uppermost surface, without the need for high-vacuum equipment. The LLZO electrolyte interface layer 120 and the cathode 110 may be annealed (e.g., calcined) simultaneously.

In various examples, calcining comprises heating or annealing in an oven or furnace. For example, during such heating or annealing, the temperature of the oven or furnace may be ramped up at a rate of x °C/min from room temperature to y °C. For example, x may be a number in the range of 10-50 °C/min, or any value or range of values therein (e.g., 20 °C/min), and y may be a number in the range of 500-800 °C, or any value or range of values therein (e.g., 550-650 °C, 600 °C, etc.). The final temperature of y °C may be maintained for 1-60 minutes, as described herein, before cooling back to room temperature. Meanwhile, an oxygen-containing gas such as clean dry air (CDA) may flow through the oven or furnace at a rate in the range of 1-25 standard cubic feet per hour (SCFH), 2-50 standard liters per minute (SLPM), or any value or range of values therein (e.g., 5 -15 SCFH, 10 SCFH, 10-30 SLPM, etc.). The gas flow rate may depend on the dimensions of the oven or the furnace and the samples to be annealed, and may be optimized based on (i) the size and shape of the furnace and the samples, and (ii) the quantity of the samples. Alternatively, clean “moist” (undried) air, scuba gas, or oxygen may flow through the oven or furnace instead of CDA.

Method 200 may involve (block 230) forming the SPE layer 130, e.g., by placing the polymer separator 132 on the electrolyte interface layer 120, and depositing a solution of the polymeric electrolyte 134 onto the polymer separator. When the substrate 100, the cathode 110, and the electrolyte interface layer 120 are in the form of a multi-cell sheet or roll (e.g., containing an x-by-y array of cells), the SPE layer 130 may be laminated thereon or therewith. The solution of the polymeric electrolyte 134 may also be deposited onto the electrolyte interface layer 120 prior to placing the polymer separator 132 on the electrolyte interface layer 120, as well as afterward. The solution of the polymeric electrolyte 134 may comprise the relatively polar polymer or co-polymer, the lithium halide or pseudohalide salt, and a solvent. The solvent is generally a relatively polar organic solvent, such as acetonitrile, tetrahydrofuran, dioxane, dimethoxyethane, bis(2-methoxyethyl) ether (diglyme), methyl or ethyl acetate, dimethyl formamide, etc.

The polar polymer or co-polymer in the polymeric electrolyte 134 may have a molecular weight (e.g., a weight-average and/or number average molecular weight) of 2,000-1,000,000 g/mol (or any molecular weight or range of molecular weights therein), and may be present in the solution at a concentration of 1-300 g/l (or any concentration or range of concentrations therein), although the disclosure is not limited to these ranges. The lithium salt may be present in the solution at a concentration of 5-500 mmol/l, or any concentration or range of concentrations therein, although the disclosure is not limited to this range, either. The molar ratio of (i) lithium-binding groups in the relatively polar polymer or co-polymer to (ii) Li ions in the lithium salt may be from 1:1 to 100:1, or any ratio or range of ratios therein. For example, when the monomer(s) of the relatively polar polymer or co-polymer have a single lithium-binding group (e.g., poly[ethylene oxide], poly[meth]acrylic acid, poly[meth]acrylate esters), then the molar ratio of (i) lithium-binding groups in the relatively polar polymer or co-polymer to (ii) Li ions in the lithium salt may be the ratio of monomer units of the relatively polar polymer or co-polymer to lithium ions.

After deposition, the solvent is evaporated by drying in an oven, optionally in a vacuum. Drying may comprise heating to a temperature of 35-150 °C for 30 minutes to 24 hours, at a pressure of from 10 Torr to atmospheric pressure (about 1 atm), but the disclosure is not limited to these ranges.

Method 200 may involve (block 240) forming the anode or the ACC interface layer 140 and, also, (block 250) forming the ACC 150. These operations may be performed separately. Once formed, method 200 may involve (block 260) positioning the anode or the ACC interface layer 140 and the ACC 150 on the SPE layer 130, thus forming substantially complete (but unsealed) cells. Thus, the anode/ACC interface layer 140 and ACC 150 may also be formed as a multi-cell sheet or roll, and laminated onto the exposed surface of the SPE layer 130 of the substrate 100/cathode 110/electrolyte interface layer 120/SPE layer 130 stack. Alternatively, the substrate 100/cathode 110/electrolyte interface layer 120 sheet/roll, the SPE layer 130 (i.e., the porous polymer separator impregnated with the polymeric electrolyte 134) sheet/roll, and the anode/ACC interface layer 140/ACC 150 sheet/roll may be laminated together in a single process to form the cells.

In one example, a thin lithium anode is deposited by evaporation onto a thin metal ACC. The metal in the ACC 150 may be or comprise copper, nickel, zinc, tungsten, vanadium, or an alloy thereof (e.g., NiTi, NiV), and may be in the form of a foil or a thin film on a mechanical substrate, as described herein. Alternatively, a lithium metal foil may be laminated onto the SPE layer 130. In this alternative, the lithium metal foil does not need to be coated with an ACC interface layer. The lithium metal foil may then be coated with the ACC 150 by thin-film or blanket deposition techniques (e.g., evaporation, sputtering, CVD, ALD, etc.).

However, a separately-formed anode is not necessary in solid-state lithium batteries, as a lithium anode can be formed between the ACC interface layer 140 and the ACC 150 during charging, if necessary. In such anode-less examples, the ACC interface layer 140 is generally deposited on the ACC 150 by blanket deposition (e.g., sputtering, evaporation, ALD, sol-gel, etc.).

The anode/ACC interface layer 140 and ACC 150 bilayer are placed on the SPE layer 130 so that the anode/ACC interface layer 140 is in contact with the SPE layer 130, as shown in FIG. 1A. Of course, the battery cell can be made in the reverse order (i.e., the ACC may be first formed on the substrate, then the remaining layers deposited and/or formed in reverse order thereon).

Alternatively, in examples for a solid-state coin battery, the cathode 110 can be prepared in sheet form (e.g., on a removable backing) or obtained commercially, ready for use. For example, LCO, LMO, lithium nickel cobalt aluminum oxide, lithium nickel manganese cobalt oxide, lithium iron phosphate, lithium manganese iron phosphate, lithium manganese nickel oxide, and other cathode sheets (sold under the trademark/trade name NANOMYTE®) can be obtained commercially from NEI Corporation, Somerset, NJ. The cathode 110 is singulated (e.g., by laser dicing, optionally after coating with a material that absorbs the light from the laser more efficiently than the cathode 110) and placed or adhered to the inside surface of the cathode portion (e.g., cathode cup) of the coin battery package. Any laser-absorbing material that is present can be removed, and the polymeric electrolyte solution may be deposited on the cathode, followed by placement of the polymer separator thereon, and another portion of polymeric electrolyte solution deposited on the polymer separator, thereby forming the SPE.

The SPE is dried as described herein, a lithium foil anode is placed thereon, and a spacer (e.g., of or comprising stainless steel) and a spring are added to the cell in or on the cathode portion of the coin battery package. The anode portion of the coin battery package (e.g., anode cap) covers the assembly in or on the cathode portion, and the two portions of the coin battery package are crimped together (e.g., at a pressure of 10-100 kg/cm²). Alternatively, an anode-less coin cell can be made by substituting an ACC interface-coated ACC foil for the lithium foil.

### EXAMPLE

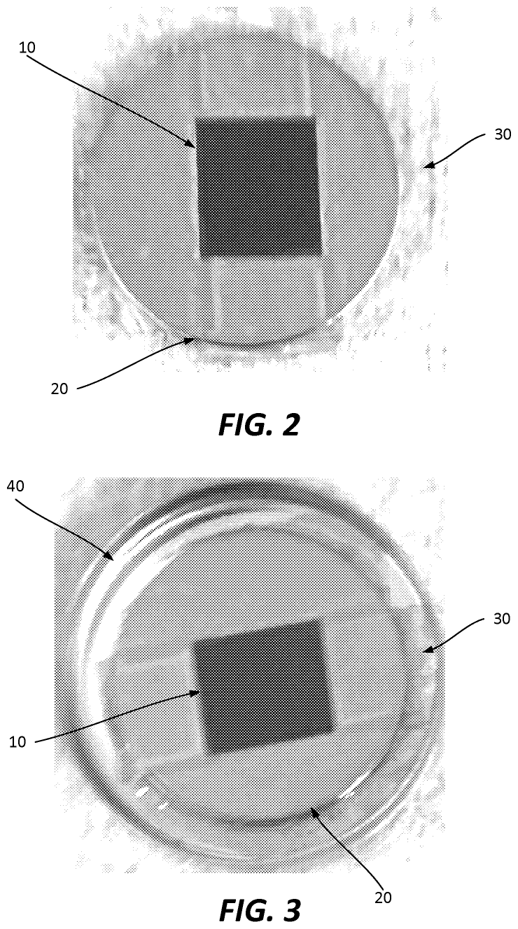

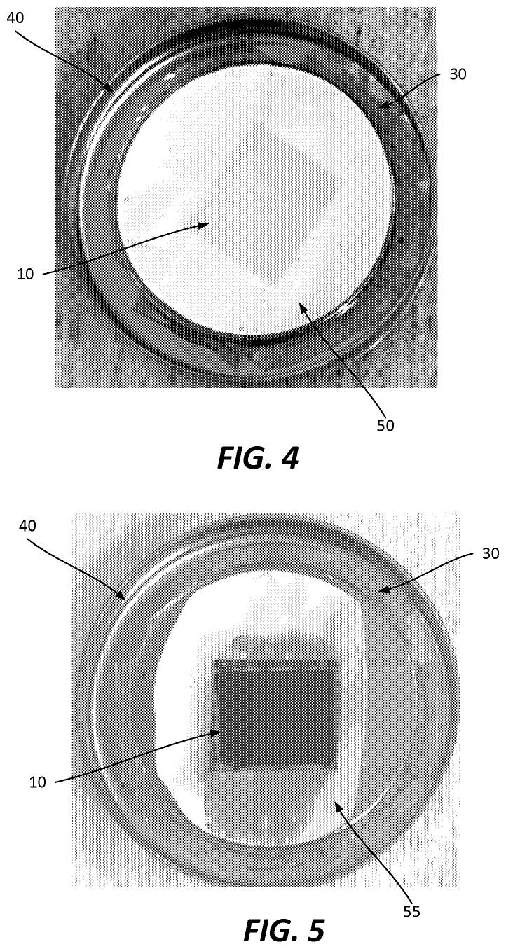

FIG. 2 is a digital photo showing a rectangular LiPON-coated LiCoO₂ cathode 10, placed approximately in the center of a circular stainless steel spacer 20, and fixed in place with Kapton tape 30. The thickness of the LiPON coating is 100 nm. FIG. 3 shows the structure of FIG. 2, placed in a circular cathode cup 40, with the Kapton tape 30 pressed down along the edge of the spacer 20, onto the cathode cup 40. As shown in FIG. 4, a circular porous polyethylene (PE) separator 50 is placed onto the exposed surface of the cathode 10 and, outside the exposed surface of the cathode 10, the Kapton tape 30. FIG. 5 shows the structure of FIG. 4 after pipetting a small amount 50μl of a solution of the solid polymer electrolyte (SPE) on the separator 50, such that the SPE solution spreads evenly over at least the surface of the cathode 10, then allowing the solvent in the SPE solution to evaporate by vacuum drying at 45 °C for 10 h, to form an SPE-infused separator 55. The SPE solution was prepared in advance and consisted of 3.096 g of poly(ethylene oxide) having a molecular weight of 70,000 g/mol and 2.020 g of lithium bis(trifluoromethanesulfonyl)imide (molar ratio of ethylene oxide [EO] monomer units to Li ions=10:1), dissolved in 84 g of acetonitrile as a solvent by stirring at 45 ° C overnight. Addition of a LiPON-coated copper foil as the ACC, a carbon-felt-sponge, and an anode cap to the structure in FIG. 5, followed by crimping at about 70 kg/cm², formed a coin battery.

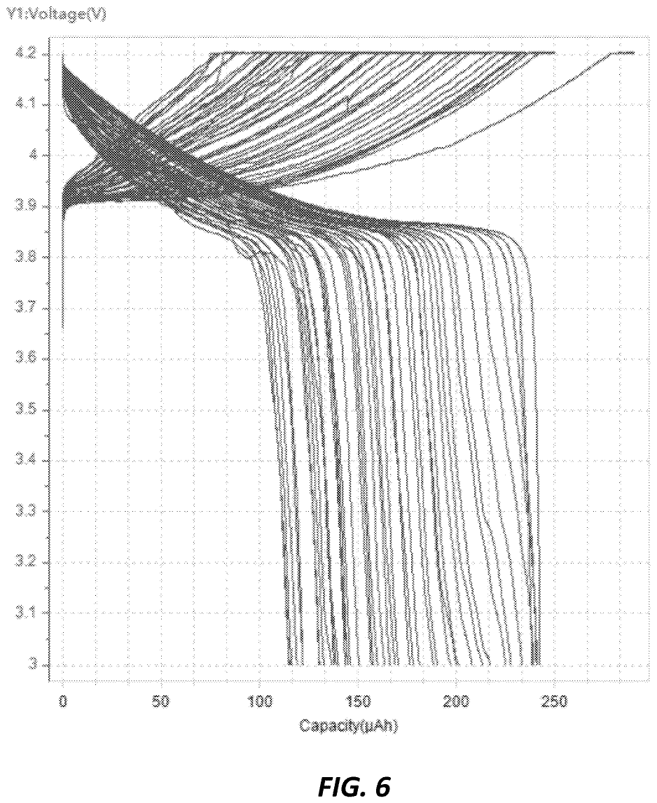

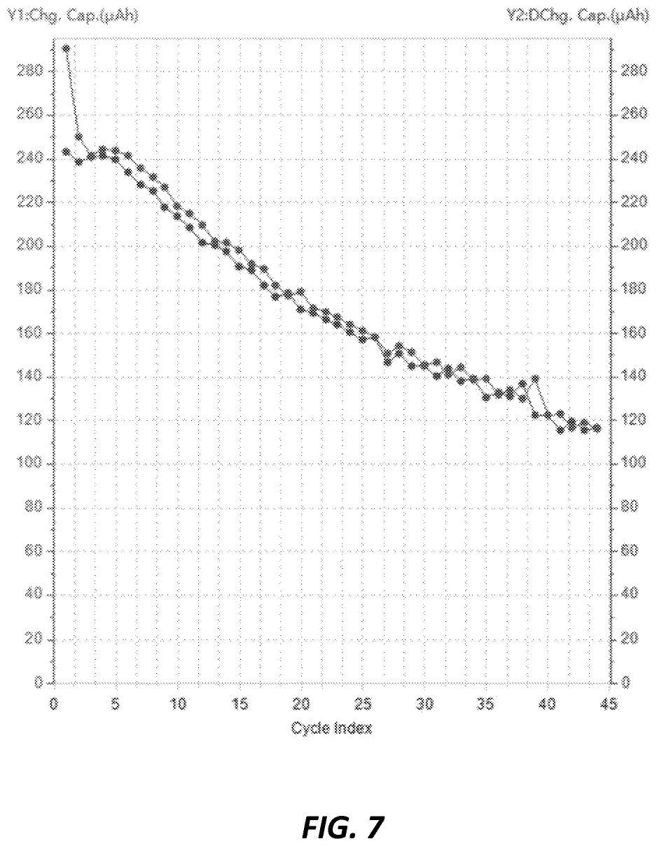

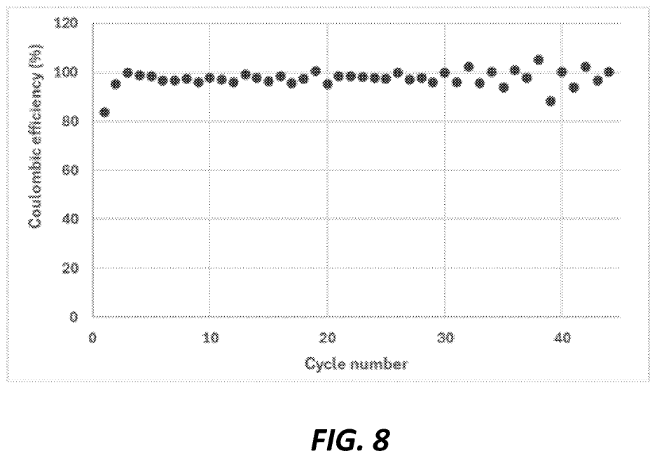

FIG. 6 is a graph showing the charge capacity and discharge capacity of the coin battery for each cycle, with the battery being charged and separately discharged at 75 μA and at 60 °C Ignoring the charge phase of the first cycle, the cycling stability is good, and the cycling performance of the coin battery is repeatable and consistent. As shown in FIG. 7, the coin battery shows the full capacity expected from the cathode 10 (i.e., ~240 uAh). As shown in FIG. 8, the coulombic efficiency (CE) is excellent. No leakage is observed.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present examples are to be considered illustrative and not restrictive.

1. A method of making a solid-state lithium battery cell, the method comprising:
depositing a cathode on a substrate;
forming an electrolyte interface layer on the cathode;
forming a solid polymer electrolyte layer over the electrolyte interface layer, wherein:
forming the solid polymer electrolyte layer comprises (a) placing a porous polymeric separator on the electrolyte interface layer and (b) depositing a solution of a polymeric electrolyte onto the porous polymeric separator,
the solution of the polymeric electrolyte comprises a polar polymer or co-polymer, a lithium salt, and a solvent,
the solution of the polymeric electrolyte at least partially penetrates into pores of the porous polymeric separator and forms the polymeric electrolyte, in a solid form, in the pores of the porous polymeric separator; an
positioning an anode current collector or an anode-current-collector interface layer and an anode current collector on the solid polymer electrolyte, thereby forming the solid-state lithium battery cell.

2. The method of claim 1, wherein depositing the cathode comprises one of sol-gel coating, screen printing, inkjet printing, spray coating, extrusion coating, pulsed laser deposition, sputtering, chemical vapor deposition, or atomic layer deposition.

3. The method of claim 1, further comprising annealing the cathode to a temperature of 500-800°C.

4. The method of claim 1, wherein forming the electrolyte interface layer comprises depositing lithium phosphorus oxynitride (LiPON), a tungsten oxide of formula WO 3+x where 0≤x≤1, or a lithium lanthanum zirconium oxide (LLZO).

5. The method of claim 1, wherein forming the electrolyte interface layer comprises RF sputtering or atomic layer deposition of LiPON.

6. The method of claim 1, wherein the electrolyte interface layer comprises carbon-doped LiPON.

7. The method of claim 1, wherein:
the electrolyte interface layer comprises a tungsten oxide of formula WO 3+x, where 0≤x≤1, and
forming the electrolyte interface layer further comprises lithiating and annealing the tungsten oxide to convert at least a portion of the tungsten oxide to Li2WO4.

8. The method of claim 7, wherein lithiating comprises one of (a) wet lithiation by immersing the tungsten oxide in a solution containing a lithium electrolyte and applying an electric field or (b) dry lithiation by sputtering or thermally evaporating lithium onto the tungsten oxide.

9. The method of claim 1, wherein the electrolyte interface layer comprises LLZO formed from an LLZO sol-gel.

10. The method of claim 9, wherein forming the LLZO comprises spin-coating, extrusion coating, dip-coating, or drip-casting the LLZO sol-gel on the cathode.

11. The method of claim 9, further comprising annealing the LLZO at 500-800 °C for 1-60 minutes in an oxygen-containing gas.

12. The method of claim 1, wherein:
the porous polymeric separator comprises polyethylene, polypropylene, or polyimide,
the porous polymeric separator has a thickness of 1-20 micrometers, and
the pores of the porous polymeric separator have an average pore size of 20-500 nm.

13. The method of claim 1, wherein the polar polymer or co-polymer comprises one of poly(ethylene oxide) having a molecular weight of 2,000-1,000,000 g/mol, ethylene oxide, vinyl alcohol, an acrylic acid ester, a methacrylic acid ester, 4-hydroxybutanoic acid lactone, or 5-hydroxypentanoic acid lactone.

14. The method of claim 1, wherein the lithium salt comprises lithium chloride, lithium iodide, lithium bis(trifluoromethanesulfonyl)imide, lithium trifluoromethanesulfonate, lithium methylsulfonate, lithium trifluoroacetate, lithium tetrafluoroborate, or lithium hexafluorophosphate.

15. The method of claim 1, wherein the solvent comprises acetonitrile, tetrahydrofuran, dioxane, dimethoxyethane, bis(2-methoxyethyl) ether, methyl acetate, ethyl acetate, or dimethylformamide.

16. The method of claim 1, wherein forming the solid polymer electrolyte layer further comprises depositing the solution of the polymeric electrolyte onto the electrolyte interface layer before placing the porous polymeric separator on the electrolyte interface layer.

17. The method of claim 1, wherein depositing the solution of the polymeric electrolyte comprises depositing an additional amount of the solution onto the porous polymeric separator after placing the porous polymeric separator on the electrolyte interface layer.

18. The method of claim 1, wherein positioning the anode current collector or the anode-current-collector interface layer and the anode current collector comprises laminating a sheet or roll containing the anode current collector or the anode-current-collector interface layer and the anode current collector onto the solid polymer electrolyte layer.

19. The method of claim 1, wherein the substrate, the cathode, the electrolyte interface layer, the solid polymer electrolyte layer, and the anode current collector or the anode-current-collector interface layer and the anode current collector are provided in a multi-cell sheet or roll form and laminated together to form a plurality of solid-state lithium battery cells.

20. The method of claim 1, wherein positioning the anode current collector or the anode-current-collector interface layer and the anode current collector comprises positioning the anode-current-collector interface layer on the solid polymer electrolyte and positioning the anode current collector on the anode-current-collector interface layer to form an anodeless solid-state lithium battery cell.
